(19) United States
(12) Patent Application Publication
(10) Pub. No.: US 2003/0135454 A1
(43) Pub. Date: Jul. 17, 2003

(54) Debit authorization post card

(76) Inventors: Joseph F. Keller, Plymouth, MN (US); Elloyd A. Hauser, Sarasota, FL (US)

Correspondence Address: Beck & Tysver, P.L.L.C., Suite 100, 2900 Thomas Avenue S., Minneapolis, MN, 55416, US

(21) Appl. No.: 10/044,225

(22) Filed: Jan. 11, 2002

(51) Int. Cl. G06F 17/60

(52) U.S. Cl. 705/39

(57) ABSTRACT

A double post card system facilitates the authorization of payment of a service fee for a returned check. A communication with a detachable, pre-printed post card is described. The double post card system is used in conjunction with a semi-automated process for printing a double post card by filling a pre-defined layout with data from a database containing a record pertaining to the returned check.

### FIELD OF THE INVENTION

The present invention relates generally to a return post card system for obtaining authorization from an account holder for payment of a fee, and more particularly to a return post card system for obtaining authorization from an account holder for payment of a service fee for a returned check.

### BACKGROUND OF THE INVENTION

To offset the costs to a business of receiving checks from customers that cannot be cashed, typically due to insufficient funds in the customers' checking accounts, many businesses implement a policy by which they charge a service fee for “bad” checks. Typically, the physical check is returned by a bank to the business to whom it was written once it is determined to be bad. The business must then contact the customer to obtain payment for the amount of the check as well as the service fee. Oftentimes, customers will attend to the check amount, but will neglect to pay the service fee. It can be relatively difficult to attend to collection of the service fees. The rules governing the Automated Clearing House (ACH) network, set by the National Automated Clearing House Association (NACHA) require a signature from the consumer authorizing the electronic debit of the service fee prior to initiating these transactions. Further, ACH rules require that this signature authorization be retained, as an original or as a microfilm (or its equivalent) copy, for two years.

What has been needed is a system and method of more easily processing the service fees associated with returned checks. Further, what has been needed is a semi-automated system and process for collecting the fee from the check-writer's account with the check-writer's permission. Still further, what has been needed is a semi-automated system and process for obtaining check-writers' written permission to debit their account for the amount of the service fee, and for semi-automatically and electronically debiting a check-writer's account and crediting the appropriate account for the service fee upon receiving permission from the check-writer.

### SUMMARY OF THE INVENTION

According to one aspect of the invention, a double or folded post card system includes a message to its recipient explaining that their signature on a detachable post card portion will authorize their account to be debited for a specified amount.

According to another aspect of the invention, a double post card system includes a printed image of a returned check previously written and processed. The post card system requests authorization for debit of a returned-check service fee from the check-writer's account via signature on a detachable return post card.

According to yet another aspect of the invention, a folded post card system includes a detachable return post card portion bearing a bar code representing a message that tells a processing system to initiate payment for a specified amount from a specified checking account.

According to another aspect of the invention, an automated system for printing a mailer sheet uses a predefined printing layout specifying locations for specific printed data and populating those locations with data from a database, each such location being linked to a field in the database.

According to yet another aspect of the invention, a database record for a check contains an indication of whether the check has been cashed. Further, this status indication is used to identify checks for which collection of a service fee should be initiated.

According to still another aspect of the invention, a folded post card system works in coordination with an electronic debit system such that upon receipt of a signature on a detachable post card portion, a bar code on the post card can be read with a bar code reader, and the system electronically and automatically initiates a transaction to debit one specified account and credit another specified account for a specified amount. The bar code contains a unique identifier. Based on this identifier, the system can access a variety of information: what account to electronically debit, when and where to apply the credit, the amount of the debit, an indication of whether payment has already been received and the like.

### BRIEF DESCRIPTION OF THE DRAWINGS

An exemplary version of a double post card system for the authorization and collection of a service fee for a returned check is shown in the figures wherein like reference numerals refer to equivalent structure throughout, and wherein:

FIG. 1 illustrates an example of one face, having first and second sides, of a mailer sheet to be folded into a double post card according to the present invention; and

FIG. 2 illustrates an example of a second face, opposite the first face of FIG. 1, of a mailer sheet to be folded into a double post card according to the present invention;

FIG. 3 schematically depicts a method according to the present invention for generating a communication to a check-writer to obtain their authorization to collect a service fee for an NSF check; and

FIG. 4 schematically depicts a method according to the present invention for collecting payment of a service fee upon receipt of authorization from a check-writer.

### DETAILED DESCRIPTION OF PREFERRED EMBODIMENTS(S)

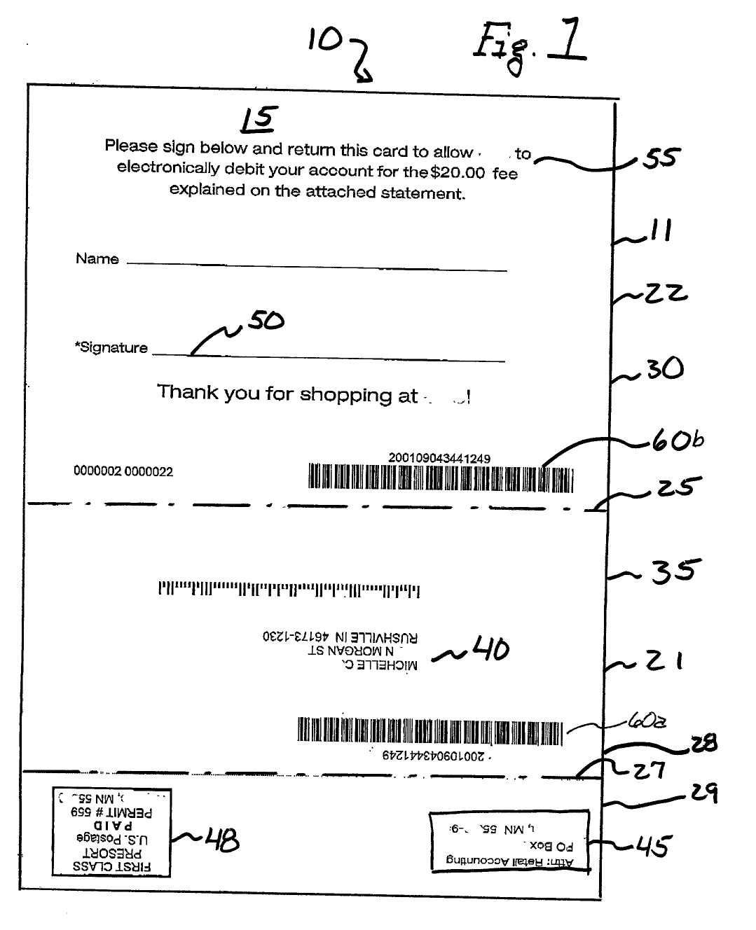

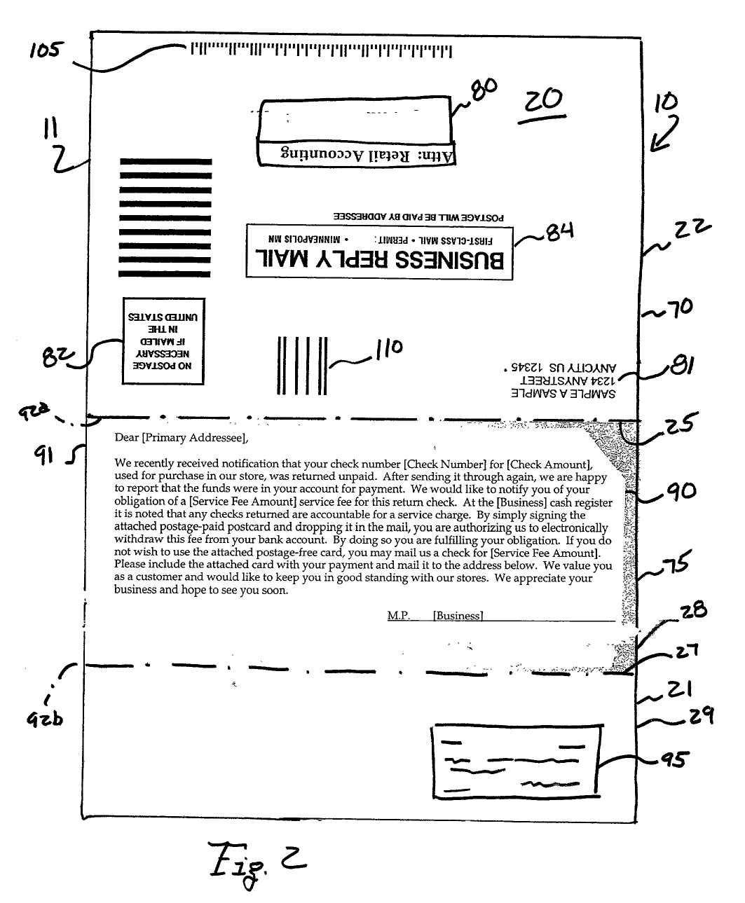

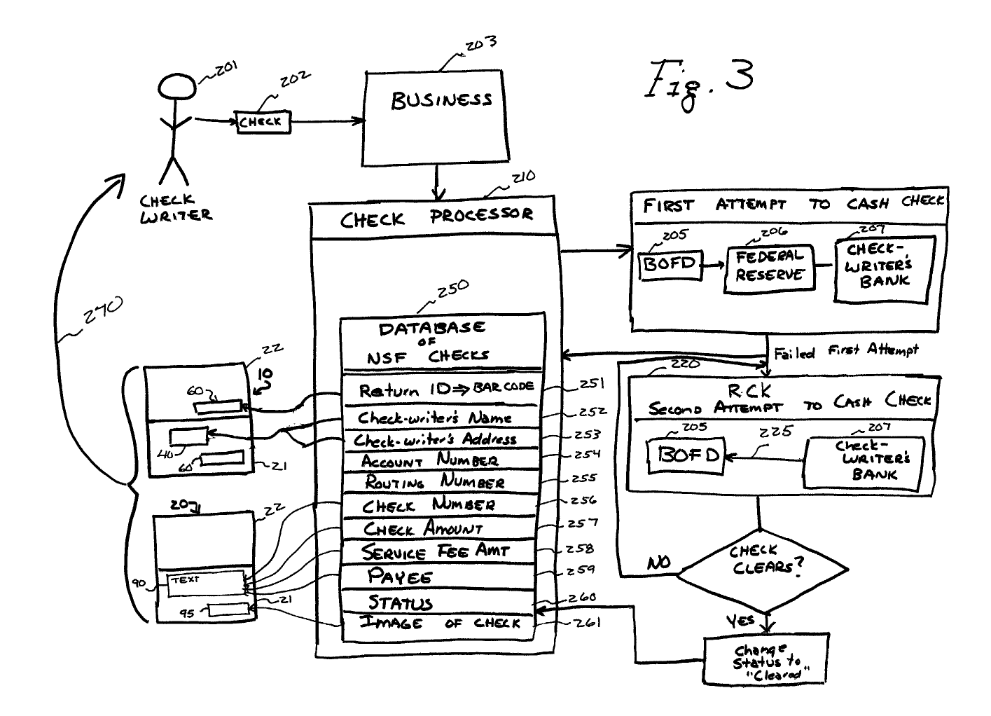

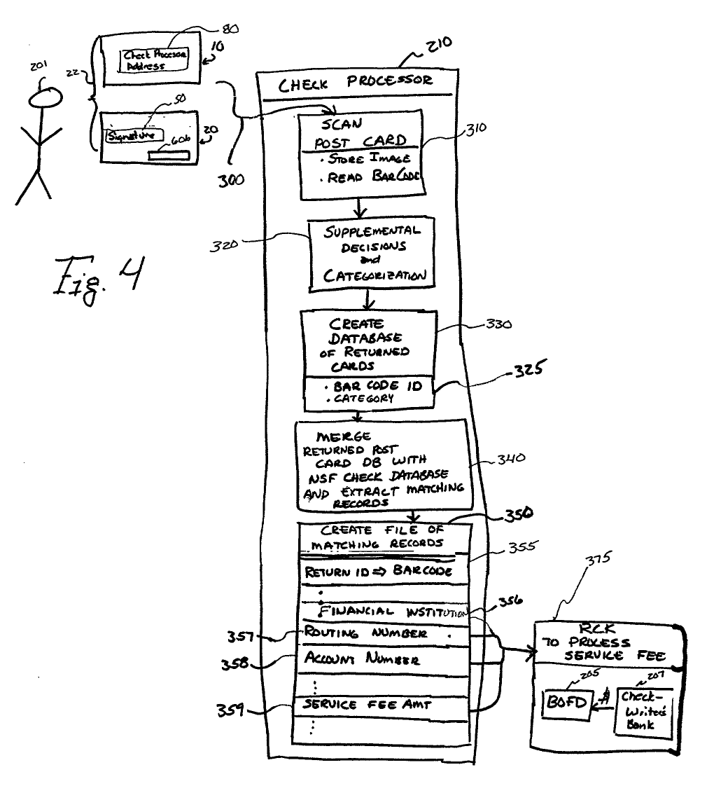

A post-card system 5 for communicating to the writer of a “returned check and for receiving authorization for payment of a service fee from the check-writer's account and initiating payment is illustrated in FIGS. 1 and 2. There are many reasons why a check might be returned without being paid; one typical reason that a check is returned is that the check is written on an account with insufficient funds (NSF) to cover the check amount. It will be understood that the system and method described herein can be used to collect a service fee on a check returned for any reason.

The system 5 uses a double-post-card 10. The post card 10 is “double” in the sense that it contains two post-card-sized communications. This is accomplished via a mailer sheet 11 folded to post card size, with appropriate address information appearing on the outside when sent to a first or primary addressee or recipient, and such that a post-card-sized portion of the mailer sheet 11 can be detached from the rest of it, with that post card portion containing appropriate address information for a second recipient or addressee.

FIG. 1 illustrates a first face or side 15, and FIG. 2 illustrates a second opposite face or side 20 of a double post card mailer sheet 11. Sheet 11 is divided generally into two sections 21, 22 respectively, with a line of reduced strength 25 therebetween. This line of reduced strength 25 allows folding therealong and allows section 21 to be selectively detached from section 22. Examples of a manner of incorporating a line of reduced strength in a sheet of paper or card stock is via perforation or tear line. Section 21 includes another line of reduced strength 27 which divides it into first and second portions 28 and 29.

As illustrated in FIG. 1, first face 15 is divided by reduced-strength line 25 into a first and second portion 30, 35. First face 15 bears written messages that will appear on the outside of the double post card 10 when it is folded along the perforation 25 for mailing to a primary addressee. These messages include a name and address 40 of the primary addressee, a return address 45, and postage or a written indication of pre-paid postage 48. These messages 40, 45, 48 all appear in the same portion 35 of the first face 15. The first face 15 also includes a bar code 60a adjacent the primary mailing address and preferably just above the primary mailing address but below perforation. As will be described below, the bar code represents a unique identifier for the subject returned check. In the other portion 30 of the first face 15, a written message includes a signature line 50. Preferably, a message 55 is linked to or adjacent the signature line 50 and explains that signing the signature line provides authorization for a specified party to collect a specified fee.

A preferred embodiment of the post card 10 includes a bar code 60b which matches bar code 60a on second portion 35. Optionally, portion 30 may include additional promotional or other information.

FIG. 2 illustrates a second face or side 20 of the mailer sheet 11. Second face 20 is divided by reduced-strength line 25 into first and second portions 70, 75. First portion 70 contains a secondary address region 80. In addition, first portion 70 also contains a secondary return address region 81 and a postage region 82 for postage or bearing an indication of pre-paid or to-be-paid postage. In typical circumstances, it will be appropriate for region 70 to include a “Business Reply Mail” indicator region 84 bearing the notation that this mailing (the second communication from the primary addressee to the secondary addressee embodied in the detachable post card section 22) qualifies under a specified permit for handling under postal regulations regarding “business reply mail” by which postage is paid by the permit holder.

The second portion 75 of second face 20 includes a text region 90. In a preferred embodiment of this mailer sheet 11 in use as described below, the text region 90 bears a description that signature on the signature line or region 50 explaining the purpose of this communication to the primary addressee. In particular, the text reminds the primary addressee of the service fee policy of the company to which the addressee wrote a bad check, and explains that payment of the service fee is requested. Further, the text explains that one method of making the service fee payment is to sign the signature region 50 and mail the detachable post card section 22 which bears the signature on one side and is already addressed to the secondary addressee which is the company or a check processing company acting on its behalf).

The text 90 may also explain that the primary addressee may write a check for the service fee and return that check along with a portion of the mailer sheet 11 in an envelope (not provided) to a specified address. In this manner, two options for attending to payment of the service fee are provided by the double post card system 10 to the primary addressee/check-writer. Preferably, the mailer sheet 11 contains additional features to facilitate this check-writing payment option. A detachable letter-sized section 91 is defined between the two lines of reduced strength 92a and 92b. It is advantageous for one of these lines of reduced strength to be co-linear with or the same as the line of reduced strength 25 that divides sections 21 and 22 and for the other to be co-linear with or the same as the line of reduced strength 27. In this manner, the mailer sheet 11 contains two lines of reduced strength. For such an embodiment, it is preferred that the bar code 60a be printed within the letter-sized section 91, so that when the check-writer includes this section 91 with a check in a mailing to the business that will process the check, adequate information is contained in the mailing to match it to the appropriate transaction. In the embodiment illustrated, this is accomplished by positioning the bar code 60a on the second face 20 within the first section 21.

In a preferred embodiment, the mailer sheet 11 includes a miniaturized image 95 of the check previously written by the primary addressee and processed and returned by a financial institution. This image may appear in any position on the mailer sheet 11 as long as it does not interfere with clear indication of mailing addresses for either the first communication (primary addressee region 40) or the second communication (secondary addressee region 80). In the illustrated embodiment, the image 95 appears on the interior face 20 of the double post card 10 when it is folded for mailing. Further, the image 95 appears on the section 21 of the mailer sheet 11 that is not part of the detachable post card section 21. In other words, preferably, the image 95 is placed where it will not be visible when either the first communication or the second is sent through the mail. The MICR line of the image of the returned check is blocked out to ensure security to the consumer.

While variations of a double post card, having different organizations of text on different sides and different halves of the post card may be implemented within the spirit of this invention, the following orientations or placements are significant: that the signature line 50 is within the same detachable portion 22 of the sheet 11 as the secondary addressee section 80; that the primary addressee region 40 and the secondary addressee section 80 are on opposite faces 15, 20 of the mailer sheet 11; and that the detachable return portion 22 of the sheet 11 bears an identifier to link the return post card to the appropriate transaction. Assignment of a unique identifier and its conversion to a printed bar code are describe below.

The dimensions or range of dimensions of a preferred post card system comply with the US Postal regulations regarding a double postcard, such as those set forth in the Domestic Mail Manual, Sections C100 and C010, incorporated herein by reference. An example, according to regulations in place at the time of the filing of this application has dimensions as follows: but subject to change 10 are as follows: a) the mailer sheet 11 has a thickness of between about 0.007 and 0.0016 inches thick; b) the double post card system 10 when folded has a width of between about 5 and 6 inches and a height of between about 3.5 and 4.25 inches; the detachable post card section 22 has a width of between about 5 and 6 inches and a height of between about 3.5 and 4.25 inches. It will be understood that Postal Service regulations change from time to time, and that appropriate size and proportion for a mailer sheet and double post card for use within the described system are optimally selected for compliance with such regulations.

The double post card system 10 further includes various indicia to facilitate the processing of the post card system through the postal service. For example, a postal code 105 may be associated with one or both of the addressees; such a postal code 105 aids the automatic processing and routing of the post card to the desired address. Another example of useful postal indicia include the vertically-oriented strips 110 which relate to the postage arrangement for “business reply mail”.

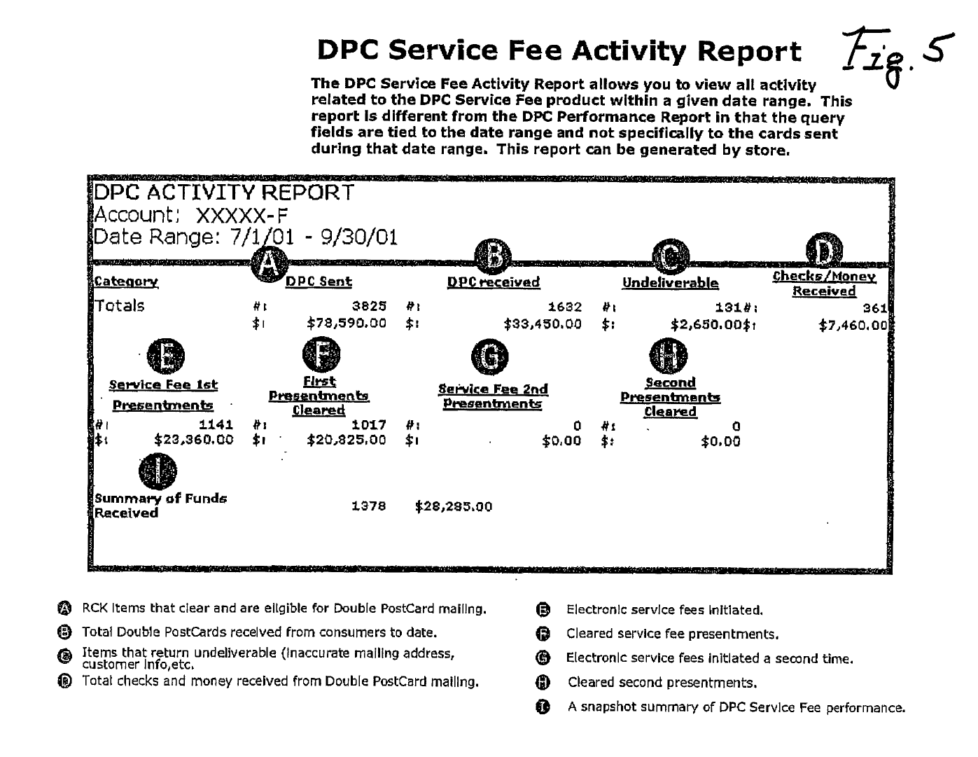

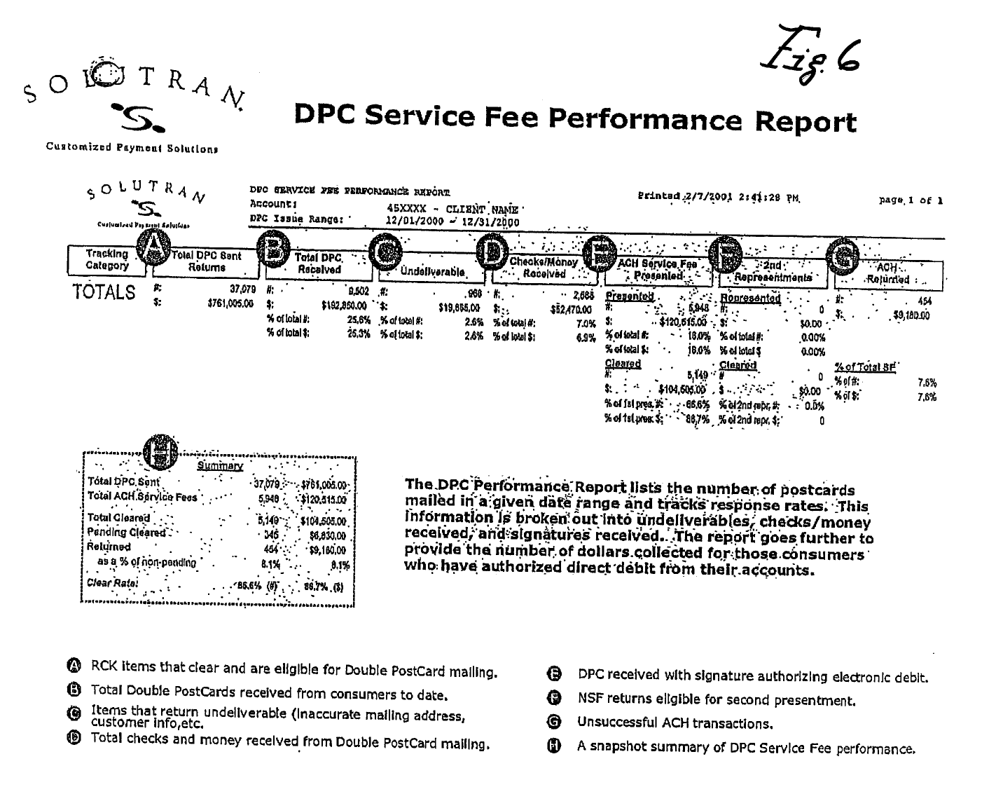

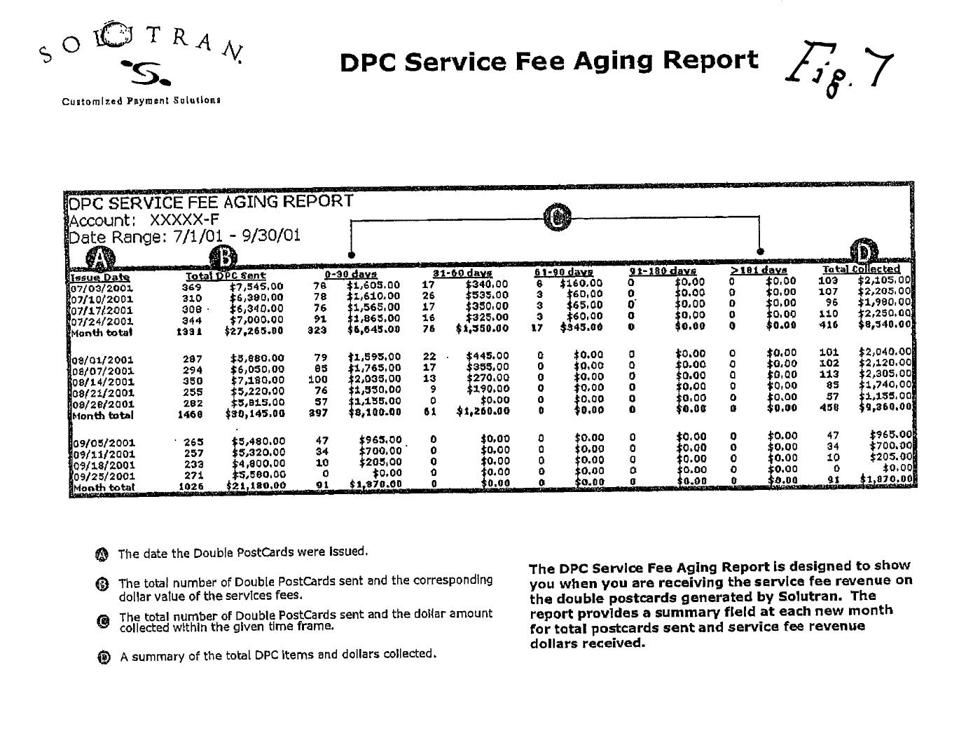

A method of generating the double post card system, with relevant data printed thereon, and for obtaining authorization for payment of a service fee is now described in conjunction with FIGS. 3 and 4. As described above, it is a challenge to cost-effectively collect service fees associated with returned checks. The double post card system 10 of the present invention assists in collecting the fee using the information readily available to the check recipient (“payee”) about the check writer and his/her/its accounts. It is typical practice for a business to contract with a third party check or payment processor (hereafter “check processor”) to attend to the processing of its checks, including all follow-up on returned checks. FIGS. 3 and 4 include such a check processor and the following description incorporates the check processor to describe the invention in a typical context. It will be understood, however, that a business might process checks itself, and that this invention might be practiced by a business itself without the use of a check processor. Further, it will be understood that while the process is described for a single check, many steps in the process will typically involve batching multiple checks or multiple transactions, and that such batched processing is facilitated by the use of the scannable bar code on the return post card, by the use of databases to maintain multiple identifiable records, and by a printing process that uses a pre-defined layout with prescribed locations for data from the database.

In typical practice, a business 203 (“Business”), upon receiving a check 202 from a customer 201 (“check-writer”), forwards the physical check 202 to its check processor 210. The processor 210 deposits the check 202 into the Business' depository bank 205 referred to in the banking industry as the Bank of First Deposit (BOFD). (This description of the depositing of the check into the Business' bank may, in some cases, be overly simplistic. The check processor may actually deposit the checks into its own account, and then make payment to the Business for the total of a batch of checks.) The check is then routed through the Federal Reserve 206 and is then presented to the consumer's financial institution 207 to generate payment of the check amount. In the event the check 202 is returned from the check-writer's bank 207 due to insufficient funds, the Business 203 may re-present (220) the check electronically to debit the check-writer's account 207. This transaction is referred to as an RCK transaction by NACHA. This transaction results in an electronic data exchange (225) between financial institutions: the check-writer's checking account is debited for the amount of the check and the business' account is credited. If the check-writer's account again has insufficient funds, this information is received by the check processor 210 and forwarded to the Business; the Business may then re-present via the check via RCK for a second time.

The Business 203 preferably has a policy which is communicated to its customers at or before a purchase is made with a check that the Business 203 may re-present any returned check electronically and that the Business charges a service fee on every returned check. Upon receiving a returned check, the check processing company 210 makes a unique entry in its database 250 regarding the returned check including a unique identifier 251 to track the activities and data regarding the collection of this particular check. Each record for a returned check includes the following information associated with the unique identifier: the check-writer's name 252; the check-writer's address 253; the check-writer's account number 254; the routing number 255 for the check writer's account; the check number 256; the check amount 257; the service fee amount 258; the payee (i.e. the Business) 259, the status of the check 260 (i.e. whether it has cleared or not); an image of the check 261.

Upon the clearing of the face value of the check, or upon the occurrence of any other criteria specified by the check processor such as the passage of specified time, the status 260 in the check record in the database is changed to reflect the “cleared” status. Periodically, and on an automated on-going basis, records from the database 250 are extracted into a file that initiates the printing and mailing of the double postcards to collect the service fee.

As described above, the printing layout for a mailer sheet includes predetermined locations for receiving information from the database associated with a returned check, preferably including at least the following: the unique barcode serialized identifier 60, the name and address of the check writer 40, a text section 90 which incorporates the check number, check amount, service fee amount, and the payee (Business); and an image of the check 95. The printing layout can be defined in a word processing program or the like which coordinates with or merges with the data base records to allow information from a database record to be printed into the proper location on the mailer sheet during printing, with each mailer sheet bearing various pieces of information from a single record in the database. Typically, multiple mailer sheets, each associated with a different record, will be printed in batches.

The mailer sheet is then folded along line 25, with face 15 bearing the primary addressee on section 21 exposed. The printed double post card is then mailed (270) to the primary addressee 201.

As depicted in FIG. 4, the primary addressee 201 (i.e. the check writer) initiates a response and applicable authorization to the secondary addressee which is typically a check processor 210 acting on behalf of the Business 203. In a preferred method, the check-writer 201 detaches the detachable section 22, signs in the designated signature location 50, and mails (300) the post card section 22 to the secondary addressee indicated in address block 80. As an alternative to returning the detachable post card 22 with a signature, the check-writer 201 might instead write a new check for the service fee and may send that check in an envelope with the unsigned detachable section 22.

Upon receiving the postcard section 22 from the check writer 201, the check processor 210 conducts several operations. The cards are scanned (310) and their images digitized and stored. If the check-writer opted to mail their post card in an envelope rather than returning it as a bare post card, the check-writer might include other materials, such as cash notes, in the envelope, and these additional materials may be imaged as well and stored in association with the post card. The unique identifier (contained in the barcode) is read and deciphered. Preferably, the bar code is read at the same time the card image is scanned and stored.

Supplemental decisions and categorization are made (320) on the received post card along with any additional data associated with that record. Such categorizations are determined by what the check-writer has returned. For example, the check-writer may have returned the signed post card, in which case it is categorized as, say, “Category 1” and the method proceeds as described below and as illustrated in FIG. 4 to process an electronic debit of the service fee from the check-writer's account. Alternatively, if the check-writer returns a new check written for the service fee amount, there is no need to process the electronic debit, and this returned card is categorized as, say, “Category 2”. Other categories may exist based on other possible actions by the check-writer 201.

Next, a database 325 is created (330) of all records of the returned post cards. Each database record contained the unique identifier from the barcode and a category determined by the check-writer's action. This returned-card database 325 is merged (340) with the original check database 250. Those records that have been matched against the original check database are extracted and a new database 350 is created (355). This new database 350, containing records of “Category 1”, initiates a respective ACH file to the banking industry.

The system also tracks and extracts other categorization elements besides ACH information. In a preferred embodiment, the postcard section 22 includes barcode 60 which contains a unique ID that accesses the information from a stored database regarding the payment of the service fee, including the financial institution 356, routing number 357, account number 358 and the amount of the fee to be processed 359. Thus, via the barcode, the detachable postcard section 22 effectively contains all of the information necessary for a check processing entity to initiate electronic payment (375) from the financial institution holding primary addressee's account 207 to another specified account 205. This transaction involves making a debit to the primary addressee's account and a credit to the specified account. Where a business engages a check processing company to handle processing of its checks, the credit might be to an account designated by the check processor or to an account held by the business itself, depending upon the details of such an arrangement.

Because of the information accessible via the database 250 using the barcode 60 contained on the detachable post card section 22, the service fee can be processed without having to locate or access the physical check which precipitated the service fee.

The batched processing of multiple transactions yields aggregated data about the service fees that a Business or its check processor are seeking to collect. This aggregated data can be presented in reports, such as those illustrated in FIGS. 5, 6 and 7. FIG. 5 illustrates an example of a “DPC (Double Post Card) Fee Activity Report” which presents the following information, in both numbers and dollar value:

A) checks that have cleared for their face value after RCK representment 220 which are now ripe for collection of the service fee;

B) detachable return post cards 22 that have been received;

C) the items that were undeliverable to the primary addressee;

D) checks and money received for service fees with a returned post card;

E) service fees that have been presented for RCK a first time;

F) service fees collected via RCK on the first attempt;

G) service fees that have been presented for RCK a second time (after not clearing the first time)

H) services fees collected via RCK on the second attempt;

I) summary of funds received.

As will be apparent to those of skill in the art, one way that such a report can be generated is by querying a database that includes at least the following fields for each record: an indicator of whether the return post card has been received, an indicator of whether a first communication was returned as undeliverable, whether a check or money was enclosed with a return post card and the amount of that check or money, an indicator of the date of first presentment to RCK and an indicator of whether the service fee was collected via the first attempt and the amount of that service fee collected, an indicator of the date of the second presentment to RCK and an indicator of whether the service fee was collected via the second attempt and the amount of the service fee collected.

FIG. 6 is an example of a “DPC (Double Post Card) Service Fee Performance Report. This provides information similar to that given by the report of FIG. 5, with additional statistical analysis showing data in percentages and ultimately providing a “clear rate” indicating the percentage of service fees collected from those attempted using the double post card system.

FIG. 7 is an example of a “DPC Service Fee Aging Report” which shows the clearance of service fees within date ranges following the mailing date of the double post card to the primary addressee, with totals aggregated by month.

Although an illustrative version of the device is shown, it should be clear that many modifications to the device may be made without departing from the scope of the invention. For example, advantages are achieved, particularly in keeping postage costs low and in convenience, by using the double post card construction which contains the first communication as well as the second communication in a detachable section. It will be understood, however, that the first communication might be contained in another format, such as a letter, with a returnable pre-printed section associated therewith.

What is claimed is:

1. A mailer sheet comprising first and second opposite sides, each said side divided into first and second sections by a line of reduced strength allowing folding along said reduced strength line and allowing selective detachment of one section from the other; said mailer sheet including:
a) a primary addressee region on said first side, first section;
b) a secondary addressee region on said second side, second section;
c) a signature region on said first side, second section; and
d) text on said mailer sheet describing that a signature placed in said signature region constitutes authorization to withdraw a described fee from a described account.

2. A mailer sheet according to claim 1, further comprising a unique identifier associated with a record stored in a database.

3. A mailer sheet according to claim 1, further comprising a miniature image of a previously written, processed, and returned negotiable instrument.

4. A mailer sheet according to claim 1, wherein said mailer sheet is sized such that when folded along said line of reduced strength, and complies with US Postal regulations for double postcard.

5. A mailer sheet according to claim 1, wherein said second section is 4.25 inches by 6 inches.

6. A mailer sheet according to claim 1, wherein said first section is 4.25 inches by 6 inches.

7. A mailer sheet according to claim 1 of card stock material.

8. A mailer sheet according to claim 1, wherein said line of reduced strength is a perforated line.

9. A method of generating a communication to a check-writer, comprising the steps of:
a) storing in a database information appearing on a previously written and processed check, said information including the name and address associated with the account on which the check is written, the account number, the routing number and the check number;
b) providing a mailer sheet having first and second opposite sides, each said side divided into first and second sections by a line of reduced strength allowing folding along said reduced strength line and allowing selective detachment of one section from the other;
c) generating a print layout for said mailer sheet including:
i) a primary addressee region on said first side, first section;
ii) a secondary addressee region on said second side, second section;
iii) text region on said mailer sheet for receiving text describing that a signature placed in said signature region constitutes authorization to withdraw a described fee from a described account;
d) printing on said mailer sheet the check-writer's name and address in the primary addressee region;
e) printing on said mailer sheet an image of a check that was previously processed; and
f) printing on said mailer sheet a secondary addressee in the secondary addressee region.

10. A method according to claim 9, wherein said information further includes the amount of a service fee to be charged for an NSF check, and said method further includes the step of:
g) printing on said mailer sheet the amount of said service fee.

12. A method according to claim 10, wherein said information further includes the amount for which the check was written, and said method further includes the step of:
g) printing on said mailer sheet said check amount.

13. A method according to claim 10, wherein said information further includes the payee to whom the check was written, and said method further includes the step of:
g) printing said payee on said mailer sheet.

14. A method according to claim 10, wherein said information further includes the amount of the service fee to be charged for an NSF check, the check amount and the payee to whom the check was written, and said method further including the step of:
g) printing on said mailer sheet within said text region and within the context of a textual message the specified fee, the check amount and the payee name.

15. A method according to claim 10, further comprising the steps of:
g) storing in said database record a unique identifier; and
h) printing said unique identifier on said mailer sheet.

16. A method according to claim 15, wherein one said detachable section of said mailer sheet is post card size and on one said side bears the address of the secondary addressee and said unique identifier is printed on said detachable section of said mailer sheet.

17. A method of securing signature authorization for payment of a specified fee from a specified account, comprising the steps of:
a) establishing a database with a record containing a unique identifier, the amount of the specified fee, and account identifying information;
b) generating a communication having a detachable return portion containing a unique bar code, said bar code representing said unique identifier;
c) receiving said detachable return portion bearing the signature of the account holder authorizing debit of the specified fee from the specified account;
d) reading the unique identifier on said signed detachable return portion;
e) generating a command to electronically debit the specified account for the amount and from the account identified in said database record associated with said unique identifier.

18. A method according to claim 17, further comprising the steps of:
f) after the step of reading the unique identifier, generating a second database having a record for the received signed detachable portion, said record containing the unique identifier;
g) merging said first and second databases;
h) extracting records that exist in both databases;
i) generating a file containing said extracted records, each said record including the unique identifier, the specified fee amount, and identifying account information for the account to be debited and identifying account information for a second account to be credited;
j) initiating the electronic debit from the first account to the second account via the banking industry's Automated Clearing House.
